(19) United States
(12) Patent Application Publication
(10) Pub. No.: US 2026/0147982 A1
(43) Pub. Date: May 28, 2026

(54) METHOD AND APPARATUS FOR REVISING TEXT INFORMATION, DEVICE, AND MEDIUM

(71) Applicant: Beijing Zitiao Network Technology Co., Ltd., Beijing (CN)

(72) Inventors: Huiyu MAI, Beijing (CN); Jian LIAO, Beijing (CN); Gang BAI, Beijing (CN); Mingke SONG, Beijing (CN)

(21) Appl. No.: 19/399,388

(22) Filed: Nov. 24, 2025

(30) Foreign Application Priority Data
Nov. 25, 2024 (CN) 202411697825.3

(51) Int. Cl. G06F 40/166; G06F 16/332

(52) U.S. Cl. CPC G06F 40/166; G06F 16/332

(57) ABSTRACT

The present disclosure provides a method and an apparatus for revising text information, a device, and a medium. A specific implementation of the method includes: acquiring original text information to be processed; generating a query statement based on the original text information, where the query statement is used for searching for a retrieval key point involved in the original text information; searching specified data based on the query statement to obtain reference information related to the retrieval key point; assessing the consistency between the reference information and the retrieval key point; and revising the original text information based on an assessment result.

### CROSS-REFERENCE TO RELATED APPLICATIONS

The present application is based on and claims the benefit of the priority to the Chinese application No. 202411697825.3 filed on Nov. 25, 2024, the disclosure of which is incorporated herein by reference in its entirety.

### TECHNICAL FIELD

Embodiments of the present disclosure relate to the field of text processing technologies and, in particular, to a method and an apparatus for revising text information, a device, and a medium.

### BACKGROUND

With the continuous development of machine learning technologies, artificial intelligence models may provide people with more and more services. At present, many artificial intelligence models may provide people with copy generation services. For example, corresponding copy may be generated according to images or scene descriptions for users to use, which provides great convenience for users. However, the generated copy usually has knowledge or factual errors. At present, in the related art, errors in the copy generated by the artificial intelligence model may only be checked by the users themselves.

### SUMMARY

Embodiments of the present disclosure describe a method and an apparatus for revising text information, a device, and a medium.

According to a first aspect, there is provided a method for revising text information, the method including: acquiring original text information to be processed; generating a query statement based on the original text information, the query statement being used for searching for a retrieval key point involved in the original text information; searching specified data based on the query statement to obtain reference information related to the retrieval key point; assessing the consistency between the reference information and the retrieval key point to obtain an assessment result; and revising the original text information based on the assessment result.

According to a second aspect, there is provided an apparatus for revising text information, the apparatus including: an acquisition unit configured to acquire original text information to be processed; a generation unit configured to generate a query statement based on the original text information, the query statement being used for searching for a retrieval key point involved in the original text information; a search unit configured to search specified data based on the query statement to obtain reference information related to the retrieval key point; an assessment unit configured to assess the consistency between the reference information and the retrieval key point to obtain an assessment result; and a revision unit configured to revise the original text information based on the assessment result.

According to a third aspect, there is provided a computer program product including a computer program, where the computer program, when executed by a processor, implements the method according to any one of the first aspect.

According to a fourth aspect, there is provided a computer-readable storage medium having a computer program stored thereon, where the computer program, when executed in a computer, causes the computer to execute the method according to any one of the first aspect.

According to a fifth aspect, there is provided an electronic device including a memory and a processor, where the memory has executable code stored thereon, and the processor, when executing the executable code, implements the method according to any one of the first aspect.

### BRIEF DESCRIPTION OF THE DRAWINGS

FIG. 1 is a schematic diagram of an exemplary system architecture to which embodiments of the present disclosure are applied;

FIG. 2 is a flowchart of a method for revising text information according to an exemplary embodiment of the present disclosure;

FIG. 3 is a schematic diagram of a scenario of revising text information according to an exemplary embodiment of the present disclosure;

FIG. 4 is a flowchart of another method for revising text information according to an exemplary embodiment of the present disclosure;

FIG. 5 is a block diagram of an apparatus for revising text information according to an exemplary embodiment of the present disclosure; and

FIG. 6 is a schematic block diagram of an electronic device provided by some embodiments of the present disclosure.

### DETAILED DESCRIPTION

It may be understood that before using the technical solutions disclosed in the embodiments of the present disclosure, the user shall be informed of the type, range of use, use scenarios, etc., of personal information involved in the present disclosure and the authorization of the user shall be obtained in an appropriate manner in accordance with relevant laws and regulations.

For example, in response to receiving an active request from a user, prompt information is sent to the user to clearly prompt the user that the requested operation will require access to and use of personal information of the user. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying and obtaining user's authorization is only illustrative and does not limit the implementations of the present disclosure, and other methods that satisfy the relevant laws and regulations may also be applied in the implementations of the present disclosure.

The technical solutions provided in the present disclosure are further described in detail below with reference to the drawings and embodiments. It may be understood that the specific embodiments described herein are only used to explain the relevant invention, but not to limit the invention. In addition, it should be noted that, for the convenience of description, only the parts related to the relevant invention are shown in the drawings. It should be noted that the embodiments of the present disclosure and the features in the embodiments may be combined with each other when there's no conflict.

With the continuous development of machine learning technologies, artificial intelligence models may provide people with more and more services. At present, many artificial intelligence models may provide people with copy generation services. For example, corresponding copy may be generated according to images or scenes for users to use, which provides great convenience for users. However, the generated copy usually has knowledge or factual errors, such as “Dalian is the capital city of Shandong”, “Apples belong to vegetables”, and so on. At present, in the related art, errors in the copy generated by the artificial intelligence model may only be checked by the users themselves.

According to the solution for revising text information provided in the present disclosure, a query statement is generated based on original text information, where the query statement is used for searching for a retrieval key point involved in the original text information. Searching is performed in specified data based on the query statement to obtain reference information related to the retrieval key point, the consistency between the reference information and the retrieval key point is assessed to obtain an assessment result, and the original text information is revised based on the assessment result. There is no need to check for errors in the original text information by humans, so that content in the original text information that may have errors may be quickly and accurately checked out, which provides convenience for users and improves the user experience.

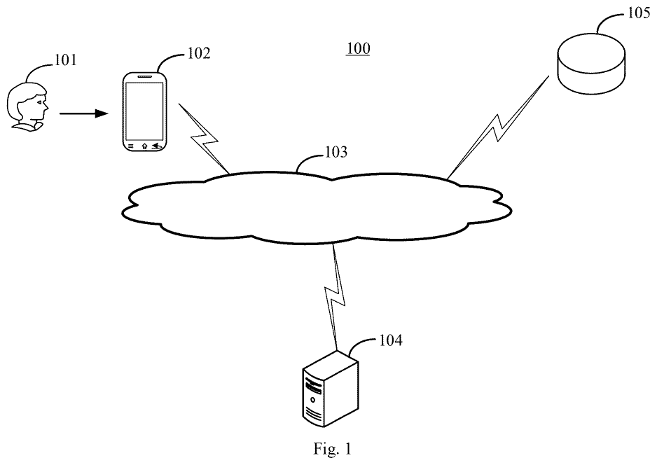

FIG. 1 is a schematic diagram of an exemplary system architecture to which embodiments of the present disclosure are applied.

As shown in FIG. 1, the system architecture 100 may include a terminal device 102, a network 103, a server 104, and a database 105. It should be understood that the number or type of the terminal device, the network, and the server in FIG. 1 is merely illustrative. There may be any number or type of terminal devices, networks, servers, and databases according to implementation needs.

The network 103 is used as a medium for providing a communication link between the terminal device and the server. The network 103 may include various connection types, such as a wired connection, a wireless communication link, an optical fiber cable, etc.

The terminal device 102 may interact with the server via the network 103 to receive or transmit requests, information, etc. The terminal device 102 may be various electronic devices, including but not limited to a smartphone, a tablet computer, a laptop portable computer, a desktop computer, a smart wearable device, etc.

The server 104 may perform processing on received data, such as storing and analyzing, and may also send control commands or requests to the terminal device or other servers. The server may provide services in response to service requests of users. It may be understood that one server may provide one or more services, and the same service may also be provided by multiple servers. A large model is deployed in the server 104, and the large model may assist the server 104 in providing services for the terminal device 102.

Based on the system architecture shown in FIG. 1, in the embodiments of the present disclosure, a user 101 may input original text information to be processed and guidance information through the terminal device 102, and the terminal device 102 may send the original text information and the guidance information to the server 104 via the network 103 to instruct the large model to generate a query statement based on the original text information and the guidance information. The server 104 may return the query statement generated by the large model to the terminal device 102 via the network 103. The terminal device 102 may perform searching in the database 105 via the network 103 based on the query statement to obtain reference information. Next, the terminal device 102 may send the original text information, the guidance information, and the reference information to the server 104 via the network 103 to instruct the large model to assess the consistency between the reference information and a retrieval key point included in the original text information. The server 104 may return an assessment result obtained by the large model to the terminal device 102 via the network 103. The terminal device 102 may present the assessment result obtained by the large model to the user 101.

The present disclosure is described in detail below with reference to specific embodiments.

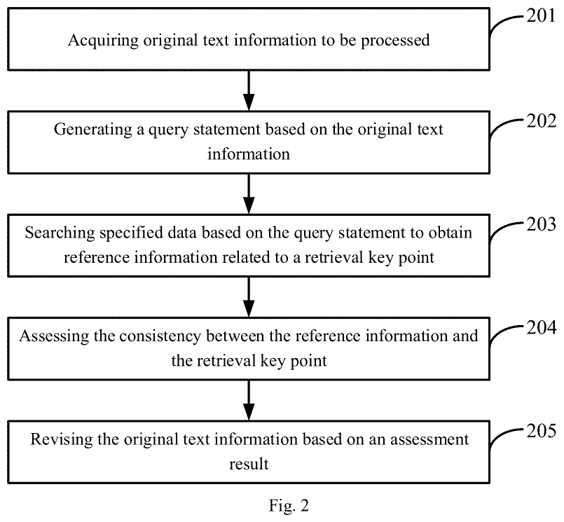

FIG. 2 is a flowchart of a method for revising text information according to an exemplary embodiment, and the method may be applied to a terminal device. In this embodiment, for ease of understanding, a terminal device capable of installing a third-party application is taken as an example. Those skilled in the art may understand that the terminal device may include but is not limited to a mobile terminal device such as a smartphone, a smart wearable device, a tablet computer, etc. The method may include the following steps.

As shown in FIG. 2, in step 201, original text information to be processed is acquired.

In this embodiment, a third-party application is installed in the terminal device, and the third-party application may be a client that may provide a text error correction function. The client may first acquire original text information to be processed, and the original text information may be text information that needs to be assessed for errors. For example, the original text information may be copy generated by an artificial intelligence model.

Specifically, in an implementation, the client may provide a text input interface for a user through an interface of the text error correction function, and the user may input the original text information through the text input interface. For example, the text input interface may include a text input box, and the user may directly input the original text information into the text input box. For another example, the text input interface may further include a file import button, and the user may import a document including the original text information into the client through the file import button.

In another implementation, the client may further provide a shortcut button for the user, and the user may import the original text information through the shortcut button. For example, the client also provides a copy generation service for the user, and after the copy is generated, the user may be provided with a one-click shortcut button, and the user may trigger the one-click shortcut button to call the error correction service of the client to acquire the generated copy as the original text information to be processed. It may be understood that the original text information to be processed may also be acquired in other ways, and the specific way of acquiring the original text information to be processed is not limited in this embodiment.

### In Step 202, a Query Statement Is Generated Based on the Original Text Information.

In this embodiment, the query statement may be used for searching for a retrieval key point involved in the original text information, and the retrieval key point may be content information belonging to a preset field. For example, the query statement may be a statement including a retrieval term and/or a retrieval question, and a preset separator may be used to separate different retrieval terms or retrieval questions. For example, the retrieval key point may be objective knowledge or factual content information involved in the original text information. The preset field may include but is not limited to a current affairs news field, a science and technology field, a humanities and history field, a natural geography field, a medical and health field, an environmental science field, etc. It may be understood that the specific scope of the preset field is not limited in this embodiment.

In this embodiment, the target large model may be any type of large language model that provides services for the client, the target large model is deployed in a server, and the client may interact with the target large model deployed in the server via a network. For example, after a user triggers a preset operation, the client may send to the server the acquired original text information and guidance information for the target large model. The server may input the received original text information and the received guidance information into the target large model to instruct the target large model to generate the query statement based on the original text information. The guidance information for the target large model may be input by the user, or may be preset and stored in the client, and the specific source of the guidance information is not limited in this embodiment.

Specifically, in an implementation, the target large model may be instructed to directly traverse and parse the original text information from beginning to end, and in the process of traversing and parsing, a retrieval key point belonging to the preset field may be detected, and summary information may be generated based on the detected retrieval key point. Finally, the query statement is generated based on the summary information.

In another implementation, the target large model may also be instructed to extract at least one text segment involving the retrieval key point from the original text information, generate at least one piece of target atomic fact information corresponding to the retrieval key point based on the text segment, and generate the query statement based on the target atomic fact information. The text segment is taken from the original text, and one or more pieces of target atomic fact information may be generated corresponding to each text segment. The target atomic fact information may be a basic fact or data point that may no longer be further subdivided in the original text information, and has a clear definition and a clear expression.

For ease of understanding, a specific example is given below. For example, the original text information A may include the following content:
[Hello everyone, today let's talk about a very important topic: how to distinguish apple snails, and I will tell you why you must never eat them!
Did you know that apple snails are actually an alien species from the tropical and subtropical regions of South America? In the 1970s, it was introduced to Asia as a food resource. However, this seemingly harmless snail has a huge hidden danger.
Amazingly, the apple snail contains up to 6,000 parasites, which are extremely harmful to human health. So, how to avoid accidentally eating it?]

The guidance information B for the target large model may include the following content:
[You are an expert in copywriting. You have extensive and comprehensive knowledge and experience, and you are good at extracting knowledge content segments from the copy, decomposing the content segments into atomic fact information, and generating query statements based on the atomic fact information.
I will provide you with a piece of copy, and you need to complete the following tasks:
Step 1: analyze the events or content in the copy, and extract knowledge key point content segments therefrom, for example, historical events, news and current affairs, scientific knowledge, natural knowledge, etc.
Step 2: generate at least one piece of atomic fact information based on the content segments extracted in the first step.
Step 3: generate a complete retrieval term suitable for search engines based on the atomic fact information generated in the second step. If there are multiple retrieval terms, please separate them with [next].]

The original text information A and the guidance information B may be sent to the server and input into the target large model. Under the guidance of the guidance information B, the target large model extracts a text segment based on the original text information A, the content of which is as follows:
[The apple snail is actually an alien species from the tropical and subtropical regions of South America. In the 1970s, it was introduced to Asia as a food resource.
The apple snail contains up to 6,000 parasites, which are extremely harmful to human health.]

Then, target atomic fact information is generated based on the above text segment, the content of which is as follows:
[1. The apple snail comes from the tropical and subtropical regions of South America;
2. The apple snail was introduced to Asia in the 1970s;
3. The apple snail was introduced to Asia as a food;
4. The apple snail contains up to 6,000 parasites;
5. Parasites are extremely harmful to human health.]

Finally, a query statement is generated based on the target atomic fact information, the content of which is as follows:
[The original place of the apple snail [next] Does the apple snail originate from South America? [next] The time when the apple snail was introduced to Asia [next] The reason why the apple snail was introduced to Asia [next] Was the apple snail introduced as food? [next] Does the apple snail have parasites in it? [next] How many parasites are there in the apple snail? [next] Parasites in the human body [next]]
It may be understood that the above is only an example provided in this embodiment, and part of the content in the example is not necessary and may be omitted, and other content may be added to the example. The specific content of the original text information and the guidance information is not limited in this embodiment.

In step 203, specified data is searched based on the query statement to obtain reference information related to the retrieval key point.

In this embodiment, the target large model may return the generated query statement to the client in the terminal device via the network. The client may directly use the query statement to perform searching. For example, a search interface may be directly called to perform searching in the specified data using the query statement, so as to obtain the reference information related to the retrieval key point. The specified data may include but is not limited to a local database, an external database with query permission, any data that may be queried over the Internet, etc. It may be understood that the specific source of the specified data is not limited in this embodiment. The reference information related to the retrieval key point may be a search result obtained by using the query statement to perform searching.

In step 204, the consistency between the reference information and the retrieval key point is assessed, and in step 205, the original text information is revised based on the assessment result.

In this embodiment, the client may further instruct the target large model to assess the consistency between the reference information and the retrieval key point based on the reference information. Specifically, the original text information, the reference information, and the guidance information may be input into the target large model via the network and the server; or a text segment involving the retrieval key point in the original text information, the reference information, and the guidance information may be input into the target large model via the network and the server; or the original text information, a position identification corresponding to the text segment involving the retrieval key point in the original text information, the reference information, and the guidance information may be input into the target large model via the network and the server. The target large model may assess the consistency between the reference information and the retrieval key point based on the input information, and return the obtained assessment result to the client. The client may output the assessment result obtained by the target large model to the user through a user interface.

In this embodiment, the assessment result may include indication information for indicating whether the reference information is consistent with the retrieval key point, and if the reference information and the retrieval key point are not consistent, the assessment result may further include difference information between the reference information and the retrieval key point. For example, if the content of the reference information C is consistent with that of the retrieval key point D, the indication information may be [The copy content is consistent with the reference information]. If the contents are not consistent, the indication information may be [The copy content is not consistent with the reference information. The reference information indicates that . . . which is different from that indicated by the copy content in that . . . ]

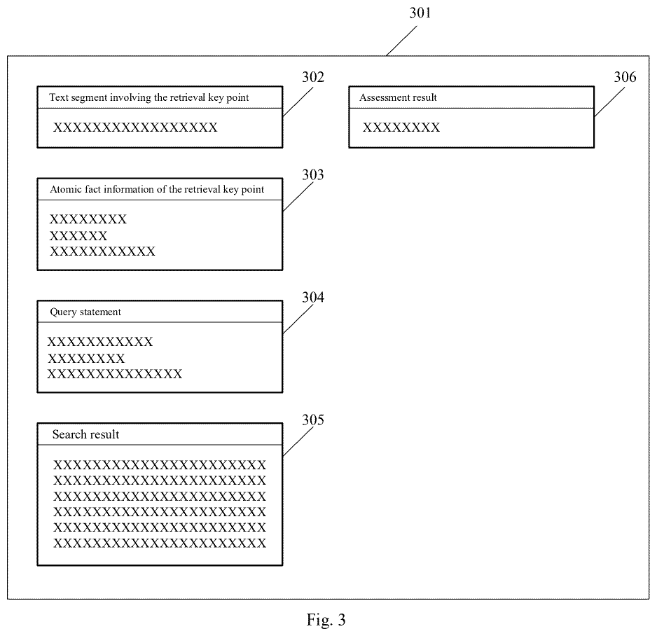

In this embodiment, in addition to outputting the assessment result, the client may further output at least one of the following content: a text segment involving the retrieval key point, target atomic fact information corresponding to the retrieval key point, the query statement, and the reference information. For example, as shown in FIG. 3, an interface 301 is an assessment result display interface provided by the client, where the content of the text segment involving the retrieval key point may be displayed in a text area 302; the target atomic fact information corresponding to the retrieval key point may be displayed in a text area 303; the query statement may be displayed in a text area 304; the reference information (i.e., the search result) obtained by searching based on the query statement may be displayed in a text area 305; and the assessment result returned by the target large model may be displayed in a text area 306.

Further, after step 205 is completed, the client may instruct the target large model to modify the original text information based on the reference information at least in the case that the reference information and the retrieval key point are not consistent. For example, in an implementation, if the reference information and the retrieval key point are not consistent, the client may directly instruct the target large model to modify the original text information based on the reference information. In another implementation, if the reference information and the retrieval key point are not consistent, the client may provide a button for the user through the user interface, and after the user triggers the button, the client instructs the target large model to modify the original text information based on the reference information.

Specifically, when the client instructs the target large model to modify the original text information based on the reference information, the text content to be modified in the original text information and the context of the text content to be modified may be acquired first. For example, the client may provide an input interface for the user, and the user may input the text content to be modified in the original text information and the context of the text content to be modified through the input interface. For another example, the client may also directly analyze the position of the text content to be modified in the original text information based on the assessment result, and acquire the text content to be modified and the context of the text content to be modified from the original text information.

Next, the modification information for modifying the text content to be modified and the guidance information may be determined. For example, the client may provide a modification interface for the user, and the user may input the modification information for modifying the text content to be modified and the guidance information through the modification interface. For another example, the client may also analyze the assessment result, determine the modification information for modifying the text content to be modified based on a preset rule or a pre-trained model, and acquire the preset guidance information. It may be understood that the specific manner of determining the modification information for modifying the text content to be modified and the guidance information is not limited in this embodiment.

Finally, the text content to be modified, the guidance information, the modification information, and the context of the text content to be modified may be sent to the target large model. The target large model may modify the text content to be modified based on the guidance information and the modification information. Based on the context of the text content to be modified, the modified text content is inserted between the context to obtain the modification result. The modification result is then returned to the client. On the one hand, the client may display the modification result to the user, and on the other hand, the client may modify the original text information based on the modification result. For example, the client may find the modified text content based on the context of the text content to be modified, and modify the content to be modified with the modification result.

Since the error text information may be modified in this embodiment, more modification ways are provided for the user, which makes it more convenient for the user to process the text information, thus improving the user experience.

According to the method for revising text information provided in the present disclosure, a query statement is generated based on original text information, where the query statement is used for searching for a retrieval key point involved in the original text information. Searching is performed in specified data based on the query statement to obtain reference information related to the retrieval key point, the consistency between the reference information and the retrieval key point is assessed, and the original text information is revised based on the assessment result. There is no need to check for errors in the original text information by humans, so that content in the original text information that may have errors may be quickly and accurately checked out, which provides convenience for users and improves the user experience.

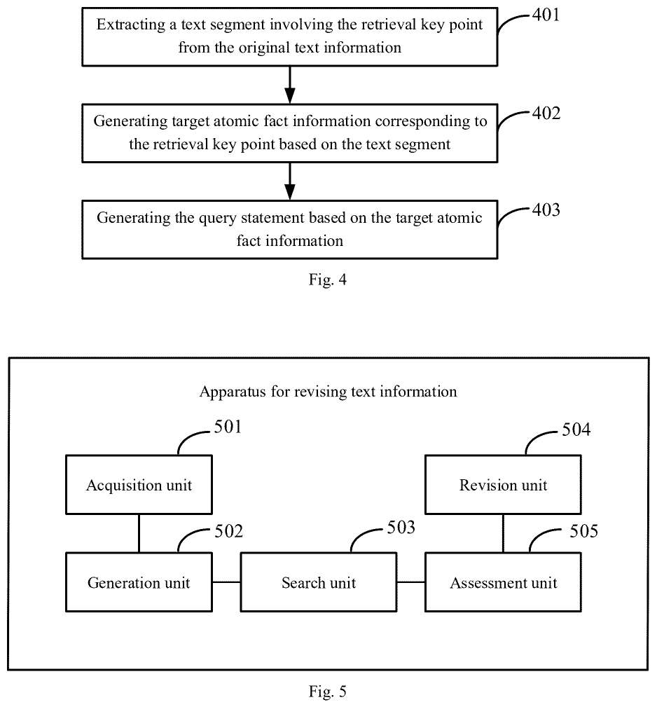

FIG. 4 is a flowchart of another method for revising text information illustrated according to an exemplary embodiment, and this embodiment describes the process of generating a query statement, which includes the following steps:
as shown in FIG. 4, in step 401, a text segment involving a retrieval key point is extracted from original text information.

In this embodiment, a client may instruct a target large model to extract, from the original text information, the text segment involving the retrieval key point. For example, in an implementation, the client may directly instruct, through the guidance information for acquiring the retrieval key point, the target large model to extract the text segment involving the retrieval key point from the original text information.

In another implementation, in addition to sending the original text information and the guidance information to the target large model, the client also sends the category of the original text information to the target large model, and adds the guidance information for the category. As such, the target large model may extract the text segment involving the retrieval key point from the original text information based on the category of the original text information and the guidance information. Specifically, since the text information of the categories such as news, science popularization, etc., usually have a high probability of containing more objective knowledge or factual content, while the text information of the categories such as emotion, inspiration, advertisement, etc., usually have a high probability of containing more subjective content, and not containing or containing less objective knowledge or factual content. Therefore, the target large model may extract the text segment involving the retrieval key point from the original text information based on the category of the original text information and the guidance information for the category. Thus, the accuracy of the extracted retrieval key point is improved, and the possibility of taking subjective content as the retrieval key point is reduced.

Further, the client may also instruct the target large model to mark the text segment involving the retrieval key point. Specifically, the target large model may acquire segment identifications corresponding to multiple content segments divided from the original text information, where the segment identifications may be, for example, numbers, etc. Multiple content segments may be divided from the original text information directly by the client, and the content segments may be marked, and the marks may be sent to the target large model at the same time. Alternatively, after analyzing the original text information, the target large model may divide multiple content segments from the original text information and mark each content segment.

Next, after extracting the text segment involving the retrieval key point, the target large model may determine the segment identification corresponding to the text segment. After assessing the consistency between the reference information and the retrieval key point, if the assessment indicates inconsistency, a target segment identification corresponding to the inconsistent retrieval key point is determined. Then, the content segment corresponding to the target segment identification in the original text information may be determined. In this way, the content with problems in the original text information may be quickly located, which provides more convenience for the user.

In step 402, target atomic fact information corresponding to the retrieval key point is generated based on the text segment.

In this embodiment, since the text segment is the content in the original text information, it may contain a deictic word, and the query statement generated based on the deictic word may greatly affect the retrieval effect. Based on this, initial atomic fact information corresponding to the retrieval key point may be generated according to the text segment. If the initial atomic fact information includes deictic word information for referring, the target content referred to by the deictic word information may be acquired based on the original text information, and the deictic word information is replaced with the target content to obtain the target atomic fact information. Thus, the accuracy of the target atomic fact information is improved, and the meaning expressed by the target atomic fact information is clearer. The specified word information may be a pronoun, a deictic phrase, etc.

For example, the text segment is [Such a super bodyguard team costs up to 180 million yuan a year for security, which is more than ten times what XXX spends], and the initial atomic fact information obtained based on the text segment may be [1. This bodyguard team costs 180 million yuan a year for security; 2. The annual security fee of this bodyguard team is more than ten times that of XXX], where “this” is the deictic word information, and it may be determined according to the original text information that “this” refers to the team of person A. Therefore, after the replacement, the target atomic fact information may be [1. The bodyguard team of A costs 180 million yuan a year for security; 2. The annual security fee of the bodyguard team of A is more than ten times that of XXX].

In step 403, a query statement is generated based on the target atomic fact information.

In this embodiment, a retrieval question may be determined first based on the target atomic fact information, and then, the query statement including a retrieval term is generated based on the retrieval question. For example, if the target atomic fact information is [1. The apple snail came from the tropical and subtropical regions of South America; 2. The apple snail was introduced to Asia in the 1970s; 3. The apple snail was introduced to Asia as a food], the retrieval question may be [1. It is necessary to determine whether the apple snail came from the tropical and subtropical regions of South America, so searching for the original place of the apple snail; 2. It is necessary to determine whether the apple snail was introduced in the 1970s, so searching for the time when the apple snail was introduced; 3. It is necessary to determine whether the apple snail was introduced to Asia for food, so searching for the reason why the apple snail was introduced]. The query statement generated based on the retrieval question may be [The original place of the apple snail [next] Does the apple snail originate from South America? [next] The time when the apple snail was introduced to Asia [next] The reason why the apple snail was introduced to Asia [next] Was the apple snail introduced as food?].

In this embodiment, a text segment involving a retrieval key point is extracted from original text information first, and then target atomic fact information corresponding to the retrieval key point is generated based on the text segment, and a query statement is generated based on the target atomic fact information. Therefore, the generation of invalid information irrelevant to the retrieval key point is avoided, the compactness of the target atomic fact information is improved, and the user experience is further improved.

It should be noted that although the operations of the method of the embodiments of the present disclosure are described in a particular order in the above embodiments, this is not required or implied that the operations must be performed in this particular order, or all the operations shown must be performed to achieve the desired results. Instead, the order of execution of the steps depicted in the flowchart may be changed. Additionally or alternatively, some steps may be omitted, multiple steps may be combined into one step for execution, and/or one step may be decomposed into multiple steps for execution.

Corresponding to the foregoing embodiments of the method for revising text information, the present disclosure further provides embodiments of an apparatus for revising text information.

As shown in FIG. 5, FIG. 5 is a block diagram of an apparatus for revising text information illustrated by the present disclosure according to an exemplary embodiment, and the apparatus may include: an acquisition unit 501, a generation unit 502, a search unit 503, an assessment unit 504, and a revision unit 505.

The acquisition unit 501 is configured to acquire original text information to be processed.

The generation unit 502 is configured to generate a query statement based on the original text information, the query statement being used for searching for a retrieval key point involved in the original text information.

The search unit 503 is configured to search specified data based on the query statement to obtain reference information related to the retrieval key point.

The assessment unit 504 is configured to assess the consistency between the reference information and the retrieval key point to obtain an assessment result.

The revision unit 505 is configured to revise the original text information based on the assessment result.

In some implementations, the operation of generating, by the generation unit 502, the query statement based on the original text information includes the following operations: extracting a text segment involving the retrieval key point from the original text information, generating target atomic fact information corresponding to the retrieval key point based on the text segment, and generating the query statement based on the target atomic fact information.

In some other implementations, the target atomic fact information corresponding to the retrieval key point is generated based on the text segment in the following manners: generating initial atomic fact information corresponding to the retrieval key point based on the text segment; and if the initial atomic fact information includes deictic word information for referring, acquiring target content referred to by the deictic word information based on the original text information, and replacing the deictic word information with the target content to obtain the target atomic fact information.

In some other implementations, the query statement is generated based on the target atomic fact information in the following manners: determining a retrieval question based on the target atomic fact information, and generating the query statement including a retrieval term based on the retrieval question.

In some other implementations, the generation unit 502 further performs the following operations: acquiring segment identifications individually corresponding to multiple content segments divided from the original text information; determining a segment identification corresponding to the text segment after extracting the text segment involving the retrieval key point; after assessing the consistency between the reference information and the retrieval key point, determining a target segment identification corresponding to an inconsistent retrieval key point if the assessment indicates inconsistency; and determining a content segment corresponding to the target segment identification in the original text information.

In some other implementations, the apparatus may further include: an output unit (not shown in the figure), and the output unit further outputs at least one of the following content: the text segment involving the retrieval key point, the target atomic fact information corresponding to the retrieval key point, the query statement, and the reference information.

In some other implementations, the assessment result includes indication information for indicating whether the reference information is consistent with the retrieval key point, and if the reference information and the retrieval key point are not consistent, the assessment result further includes difference information between the reference information and the retrieval key point.

In some other implementations, the revision unit 50 is configured to: acquire text content to be modified in the original text information; determine modification information for modifying the text content to be modified and guidance information; and modify the text content to be modified based on the guidance information and the modification information.

For the apparatus embodiments, since they basically correspond to the method embodiments, the relevant parts may be referred to the partial description of the method embodiments. The apparatus embodiments described above are only schematic, where the units described as separate parts may be or may not be physically separated, and the parts displayed as units may be or may not be physical units, that is, they may be located in one place or distributed to multiple network units. Some or all of the modules may be selected according to actual needs to achieve the purposes of the solutions of the embodiments of the present disclosure. Those of ordinary skill in the art may understand and implement them without paying any creative effort.

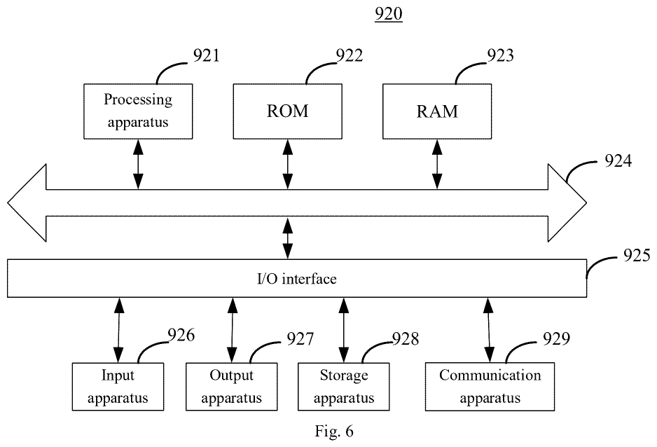

Reference is made to FIG. 6 below, which is a schematic block diagram of an electronic device provided by some embodiments of the present disclosure. The electronic device 920 is, for example, suitable for implementing the method for processing text information based on a large language model provided by the embodiments of the present disclosure. The electronic device 920 may be a terminal device or the like, and may be used to implement a client or a server. The electronic device 920 may include, but is not limited to, mobile terminals such as a mobile phone, a laptop, a digital broadcast receiver, a PDA (personal digital assistant), a tablet computer, a PMP (portable multimedia player), a vehicle-mounted terminal (e.g., a vehicle-mounted navigation terminal), and a wearable electronic device, and fixed terminals such as a digital TV, a desktop computer, and a smart home device. It should be noted that the electronic device 920 shown in FIG. 6 is only an example, which will not impose any limitation on the function and scope of use of the embodiments of the present disclosure.

As shown in FIG. 6, the electronic device 920 may include a processing apparatus (e.g., a central processing unit, a graphics processor, etc.) 921 that may perform various appropriate actions and processing according to a program stored in a read-only memory (ROM) 922 or a program loaded from a storage apparatus 928 into a random access memory (RAM) 923. The RAM 923 further stores various programs and data required for operations of the electronic device 920. The processing apparatus 921, the ROM 922, and the RAM 923 are connected to each other through a bus 924. An input/output (I/O) interface 925 is also connected to the bus 924.

Generally, the following apparatuses may be connected to the I/O interface 925: an input apparatus 926 including, for example, a touch screen, a touchpad, a keyboard, a mouse, a camera, a microphone, an accelerometer, and a gyroscope; an output apparatus 927 including, for example, a liquid crystal display (LCD), a speaker, and a vibrator; the storage apparatus 928 including, for example, a magnetic tape and a hard disk; and a communication apparatus 929. The communication apparatus 929 may allow the electronic device 920 to perform wireless or wired communication with other electronic devices to exchange data. Although FIG. 6 shows the electronic device 920 having various apparatuses, it should be understood that it is not required to implement or have all the apparatuses shown, and the electronic device 920 may alternatively implement or have more or fewer apparatuses. Each block shown in FIG. 6 may represent one apparatus or multiple apparatuses as needed.

According to the embodiments of the present disclosure, the foregoing method for processing text information based on a large language model may be implemented as a computer software program. For example, the embodiments of the present disclosure include a computer program product, which includes a computer program carried on a non-transitory computer-readable medium, where the computer program includes program code for performing the foregoing method for processing text information based on a large language model. In such an embodiment, the computer program may be downloaded and installed from a network through the communication apparatus 929, or installed from the storage apparatus 928, or installed from the ROM 922. When the computer program is executed by the processing apparatus 921, the functions defined in the method for processing text information based on a large language model provided by the embodiments of the present disclosure may be implemented.

The embodiments of the present disclosure further provide a computer-readable storage medium having a computer program stored thereon, where the computer program, when executed in a computer, causes the computer to execute the method provided by the present disclosure.

It should be noted that the computer-readable medium according to the embodiments of the present disclosure may be a computer-readable signal medium, a computer-readable storage medium, or any combination of the two. The computer-readable storage medium may be, for example, but is not limited to, an electronic, magnetic, optical, electromagnetic, infrared, or semiconductor system, apparatus, device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the embodiments of the present disclosure, the computer-readable storage medium may be any tangible medium that contains or stores a program, which may be used by or in combination with an instruction execution system, apparatus or device. In the embodiments of the present disclosure, the computer-readable signal medium may include a data signal propagated on a baseband or as a part of a carrier, and computer-readable program code is carried therein. This propagated data signal may take many forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus or device. The program code contained on the computer-readable medium may be transmitted in any suitable medium, including but not limited to: a wire, an optical cable, a radio frequency (RF), etc., or any suitable combination of the above.

The computer program code for performing the operations of the embodiments of the present disclosure may be written in one or more programming languages or a combination thereof, where the programming languages include object-oriented programming languages such as Java, Smalltalk, and C++, and may also include conventional procedural programming languages such as “C” language or similar programming languages. The program code may be executed entirely on a user's computer, partly on the user's computer, as a stand-alone software package, partly on the user's computer and partly on a remote computer, or entirely on the remote computer or server. In the case of involving the remote computer, the remote computer may be connected to the user's computer through any kind of network, including a local area network (LAN) or a wide area network (WAN), or it may be connected to an external computer (for example, connected by using Internet provided by an Internet service provider).

The embodiments in the present disclosure are all described in a progressive manner, and the same and similar parts between the embodiments may be referred to each other, and each embodiment focuses on the differences from other embodiments. In particular, the embodiments of the storage medium and the computing device are relatively simple in description because they are basically similar to the method embodiments, and the relevant parts may be referred to the partial description of the method embodiments.

Those skilled in the art should realize that, in one or more of the above examples, the functions described in the embodiments of the present disclosure may be implemented in hardware, software, firmware, or any combination thereof. When software is used to implement these functions, these functions may be stored in a computer-readable medium or transmitted as one or more instructions or codes on the computer-readable medium.

The specific embodiments described above further describe the purpose, technical solutions, and beneficial effects of the embodiments of the present disclosure in detail. It should be understood that the above are only specific implementations of the embodiments of the present disclosure, and are not intended to limit the scope of protection of the present disclosure. Any modification, equivalent replacement, improvement, etc. made on the basis of the technical solutions of the present disclosure shall be included in the scope of protection of the present disclosure.

What is claimed is

1. A method for revising text information, comprising:
acquiring original text information to be processed;
generating a query statement based on the original text information, the query statement being configured to search for a retrieval key point involved in the original text information;
searching specified data based on the query statement to obtain reference information related to the retrieval key point;
assessing consistency between the reference information and the retrieval key point to obtain an assessment result; and
revising the original text information based on the assessment result.

2. The method of claim 1, wherein the generating the query statement based on the original text information comprises:
extracting a text segment involving the retrieval key point from the original text information;
generating target atomic fact information corresponding to the retrieval key point based on the text segment; and
generating the query statement based on the target atomic fact information.

3. The method of claim 2, wherein the generating the target atomic fact information corresponding to the retrieval key point based on the text segment comprises:
generating initial atomic fact information corresponding to the retrieval key point based on the text segment;
in response to the initial atomic fact information comprising deictic word information for referring, acquiring target content referred to by the deictic word information based on the original text information; and
replacing the deictic word information with the target content to obtain the target atomic fact information.

4. The method of claim 2, wherein the generating the query statement based on the target atomic fact information comprises:
determining a retrieval question based on the target atomic fact information; and
generating the query statement comprising a retrieval term based on the retrieval question.

5. The method of claim 2, wherein the method further comprises:
acquiring segment identifications individually corresponding to multiple content segments divided from the original text information;
determining a segment identification corresponding to the text segment after extracting the text segment involving the retrieval key point;
after assessing the consistency between the reference information and the retrieval key point, determining a target segment identification corresponding to an inconsistent retrieval key point in response to the assessment indicating inconsistency; and
determining a content segment corresponding to the target segment identification in the original text information.

6. The method of claim 2, wherein the method further comprises outputting at least one of the following:
the text segment involving the retrieval key point;
the target atomic fact information corresponding to the retrieval key point;
the query statement; and
the reference information.

7. The method of claim 1, wherein the assessment result comprises indication information for indicating whether the reference information is consistent with the retrieval key point; and in response to the reference information being inconsistent with the retrieval key point, the assessment result further comprises difference information between the reference information and the retrieval key point.

8. The method of claim 1, wherein the revising the original text information based on the assessment result comprises:
acquiring text content to be modified in the original text information;
determining modification information for modifying the text content to be modified and guidance information; and
modifying the text content to be modified based on the guidance information and the modification information.

9. A non-transitory computer-readable storage medium having a computer program stored thereon, wherein the computer program, when executed in a computer, causes the computer to execute a method for revising text information, comprising:
acquiring original text information to be processed;
generating a query statement based on the original text information, the query statement being configured to search for a retrieval key point involved in the original text information;
searching specified data based on the query statement to obtain reference information related to the retrieval key point;
assessing consistency between the reference information and the retrieval key point to obtain an assessment result; and
revising the original text information based on the assessment result.

10. The non-transitory computer-readable storage medium of claim 9, wherein the generating the query statement based on the original text information comprises:
extracting a text segment involving the retrieval key point from the original text information;
generating target atomic fact information corresponding to the retrieval key point based on the text segment; and p1 generating the query statement based on the target atomic fact information.

11. The non-transitory computer-readable storage medium of claim 10, wherein the generating the target atomic fact information corresponding to the retrieval key point based on the text segment comprises:
generating initial atomic fact information corresponding to the retrieval key point based on the text segment;
in response to the initial atomic fact information comprising deictic word information for referring, acquiring target content referred to by the deictic word information based on the original text information; and
replacing the deictic word information with the target content to obtain the target atomic fact information.

12. The non-transitory computer-readable storage medium of claim 10, wherein the generating the query statement based on the target atomic fact information comprises:
determining a retrieval question based on the target atomic fact information; and
generating the query statement comprising a retrieval term based on the retrieval question.

13. The non-transitory computer-readable storage medium of claim 10, wherein the method further comprises:
acquiring segment identifications individually corresponding to multiple content segments divided from the original text information;
determining a segment identification corresponding to the text segment after extracting the text segment involving the retrieval key point;
after assessing the consistency between the reference information and the retrieval key point, determining a target segment identification corresponding to an inconsistent retrieval key point in response to the assessment indicating inconsistency; and
determining a content segment corresponding to the target segment identification in the original text information.

14. The non-transitory computer-readable storage medium of claim 10, wherein the method further comprises outputting at least one of the following:
the text segment involving the retrieval key point;
the target atomic fact information corresponding to the retrieval key point;
the query statement; and
the reference information.

15. The non-transitory computer-readable storage medium of claim 9, wherein the assessment result comprises indication information for indicating whether the reference information is consistent with the retrieval key point; and in response to the reference information being inconsistent with the retrieval key point, the assessment result further comprises difference information between the reference information and the retrieval key point.

16. The non-transitory computer-readable storage medium of claim 9, wherein the revising the original text information based on the assessment result comprises:
acquiring text content to be modified in the original text information;
determining modification information for modifying the text content to be modified and guidance information; and
modifying the text content to be modified based on the guidance information and the modification information.

17. An electronic device comprising a memory and a processor, wherein the memory has executable code stored thereon, and the processor, when executing the executable code, implements a method for revising text information, comprising:
acquiring original text information to be processed;
generating a query statement based on the original text information, the query statement being configured to search for a retrieval key point involved in the original text information;
searching specified data based on the query statement to obtain reference information related to the retrieval key point;
assessing consistency between the reference information and the retrieval key point to obtain an assessment result; and
revising the original text information based on the assessment result.

18. The electronic device of claim 17, wherein the generating the query statement based on the original text information comprises:
extracting a text segment involving the retrieval key point from the original text information;
generating target atomic fact information corresponding to the retrieval key point based on the text segment; and
generating the query statement based on the target atomic fact information.

19. The electronic device of claim 18, wherein the generating the target atomic fact information corresponding to the retrieval key point based on the text segment comprises:
generating initial atomic fact information corresponding to the retrieval key point based on the text segment;
in response to the initial atomic fact information comprising deictic word information for referring, acquiring target content referred to by the deictic word information based on the original text information; and
replacing the deictic word information with the target content to obtain the target atomic fact information.

20. The electronic device of claim 18, wherein the generating the query statement based on the target atomic fact information comprises:
determining a retrieval question based on the target atomic fact information; and
generating the query statement comprising a retrieval term based on the retrieval question.
